(19) United States
(12) Patent Application Publication
(10) Pub. No.: US 2017/0227759 A1
(43) Pub. Date: Aug. 10, 2017

(54) MOVING PHYSICAL JEWELRY OVER A DISPLAY SCREEN

(71) Applicant: Panasonic Automotive Systems Company of America, Division of Panasonic Corporation of North America, PEACHTREE CITY, GA (US)

(72) Inventors: SACHIKO KOBAYASHI, NOVI, MI (US); PATRICK HANSLITS, CLARKSTON, MI (US); JOHN SCOTT SIEGEL, AUBURN HILLS, MI (US); DAVID LYON, HUNTINGTON WOODS, MI (US); GARY L. BRADDOCK, GROSSE POINTE, MI (US); NARAYANI MITAL, ROYAL OAK, MI (US)

(73) Assignee: Panasonic Automotive Systems Company of America, Division of Panasonic Corporation of North America

(21) Appl. No.: 15/416,139

(22) Filed: Jan. 26, 2017

Related U.S. Application Data
(60) Provisional application No. 62/291,384, filed on Feb. 4, 2016.

(51) Int. Cl. G02B 25/00; B60K 35/00; G02B 7/00

(52) U.S. Cl. CPC G02B 25/005; G02B 7/00; B60K 35/00; B60K 2350/1072; B60K 2350/206; B60K 2350/2065; B60K 2350/352; B60K 2350/403

(57) ABSTRACT

A display screen arrangement is for use in a motor vehicle and includes an electronic display screen. A pair of optical elements are slidably mounted over the display screen and are movable in opposite lateral directions. An actuator is coupled to the optical elements and moves the optical elements in the opposite lateral directions. A processor is communicatively coupled to the actuator and causes the actuator to move the optical elements to positions dependent upon an image being presented on the display screen.

### CROSS-REFERENCED TO RELATED APPLICATIONS

This application claims benefit of U.S. Provisional Application No. 62/291,384 filed on Feb. 4, 2016, which the disclosure of which is hereby incorporated by reference in its entirety for all purposes.

### FIELD OF THE INVENTION

The disclosure relates to the field of display screens, and, more particularly, to display screens mounted in motor vehicles.

### BACKGROUND OF THE INVENTION

It is known in vehicles for a dashboard gauge to be framed by a stationary, round metal or plastic ring. Stationary gauges are also known to be presented on a display screen surrounded by round rings. However, these rings displayed on a display screen are merely two-dimensional, and are not physical rings. Traditional rings can be three-dimensional, but they are merely stationary jewelry.

### SUMMARY

The present invention may provide physical, movable three-dimensional components mounted over an electronic display screen. In one embodiment, the physical, movable three-dimensional component is a physical, transparent “jewel” or lens that provides a three-dimensional feel to a two-dimensional flat screen display. The “jewel” may reconfigure (e.g., move laterally, parallel to the screen) depending on what information is being provided on the display screen, and thereby visually partition and organize the information on the display.

The component may be shown and described herein as a ring. However, in other embodiments the component is something other than a ring, or has a shape other than that of a ring. The component can be of any physical shape that is mountable over the display screen.

In one embodiment, the invention comprises a display screen arrangement for use in a motor vehicle and including an electronic display screen. A pair of optical elements are slidably mounted over the display screen and are movable in opposite lateral directions. An actuator is coupled to the optical elements and moves the optical elements in the opposite lateral directions. A processor is communicatively coupled to the actuator and causes the actuator to move the optical elements to positions dependent upon an image being presented on the display screen.

In another embodiment, the invention comprises a method of operating a display screen arrangement in a motor vehicle, including providing an electronic display screen within the motor vehicle. A pair of optical elements are slidably mounted over the display screen such that the optical elements are movable in opposite lateral directions. An actuator is coupled to the optical elements. The actuator is used to move the optical elements in the opposite lateral directions. A processor is communicatively coupled to the actuator. The processor is used to cause the actuator to move the optical elements to positions dependent upon an image being presented on the display screen.

In yet another embodiment, the invention comprises a display screen arrangement for use in a motor vehicle, including an electronic display screen. An optical element is slidably mounted over the display screen. An actuator is coupled to the optical element and moves the optical element across the display screen. A processor is communicatively coupled to the actuator and causes the actuator to move the optical element dependent upon an image being presented on the display screen.

### BRIEF DESCRIPTION OF THE DRAWINGS

A better understanding of the present invention will be had upon reference to the following description in conjunction with the accompanying drawings.

FIG. 1a is a rear perspective view of one embodiment of a display screen arrangement of the present invention in a first position.

FIG. 1b is a rear perspective view of the display screen arrangement of FIG. 1a in a second position.

FIG. 2a is a front perspective view of the display screen arrangement of FIG. 1a in the first position.

FIG. 2b is a front perspective view of the display screen arrangement of FIG. 1a in the second position.

FIG. 3a is another front perspective view of the display screen arrangement of FIG. 1a in the first position.

FIG. 3b is another front perspective view of the display screen arrangement of FIG. 1a in the second position.

FIG. 4a is a front plan view of the display screen arrangement of FIG. 1a in the first position and with the display screen operating.

FIG. 4b is a front plan view of the display screen arrangement of FIG. 1a in the second position and with the display screen operating.

FIG. 5 is a block diagram of another embodiment of a display screen arrangement of the present invention

FIG. 6 is a flow chart of one embodiment of a method 600 of the present invention for operating a display screen arrangement in a motor vehicle.

### DETAILED DESCRIPTION OF THE PREFERRED EMBODIMENTS

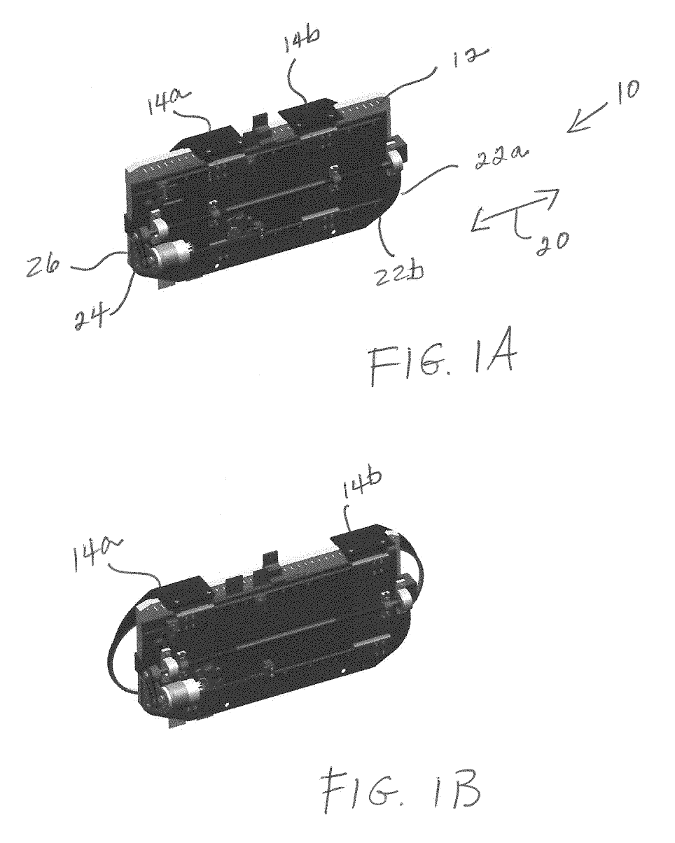

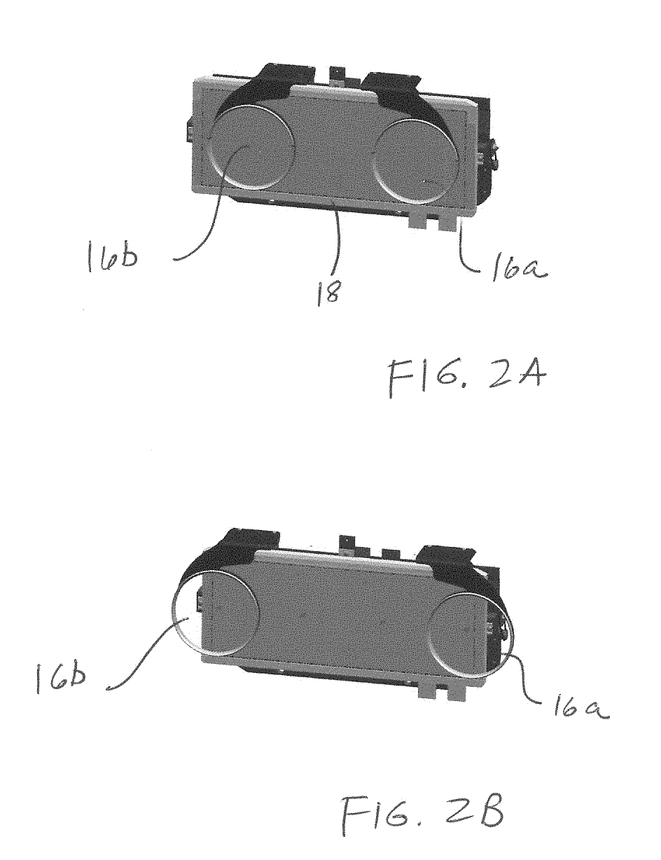

FIG. 1a illustrates one embodiment of a display screen arrangement 10 of the present invention including a display screen frame 12 having two mounting brackets 14a-b attached to frame 12 and to respective circular jewels 16a-b (FIG. 2a). Each of jewels 16a-b is disposed over a respective portion of a rectangular display screen 18. Each of jewels 16a-b may be in the form of a magnifying lens or may have some other optical characteristic. Alternatively, each of jewels 16a-b may be formed of acrylic, and may have no special optical characteristic other than being substantially transparent.

Mounting brackets 14a-b are laterally slidable in directions indicated by double arrow 20 along horizontal rods 22a-b that are attached to frame 12 such that jewels 16a-b are also laterally slidable over and respect to display screen 18. FIGS. 1b and 2b illustrate the positions of brackets 14a-b and jewels 16a-b after both brackets 14a-b and jewels 16a-b move in laterally outward directions relative to their starting positions shown in FIGS. 1a and 2a. A motor 24 and belt 26 may drive brackets 14a-b and jewels 16a-b in directions 20 under the control of an electronic processor (not shown).

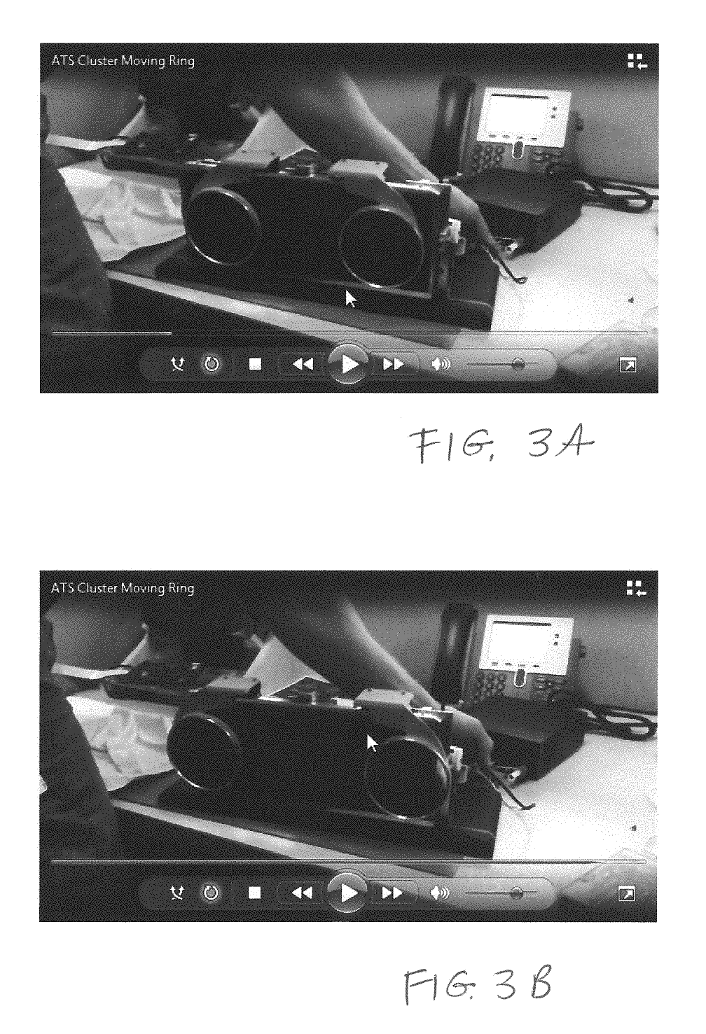

FIG. 3a is another view of display screen arrangement 10 in the position of FIG. 2a; and FIG. 3b is another view of display screen arrangement 10 in the position of FIG. 2b.

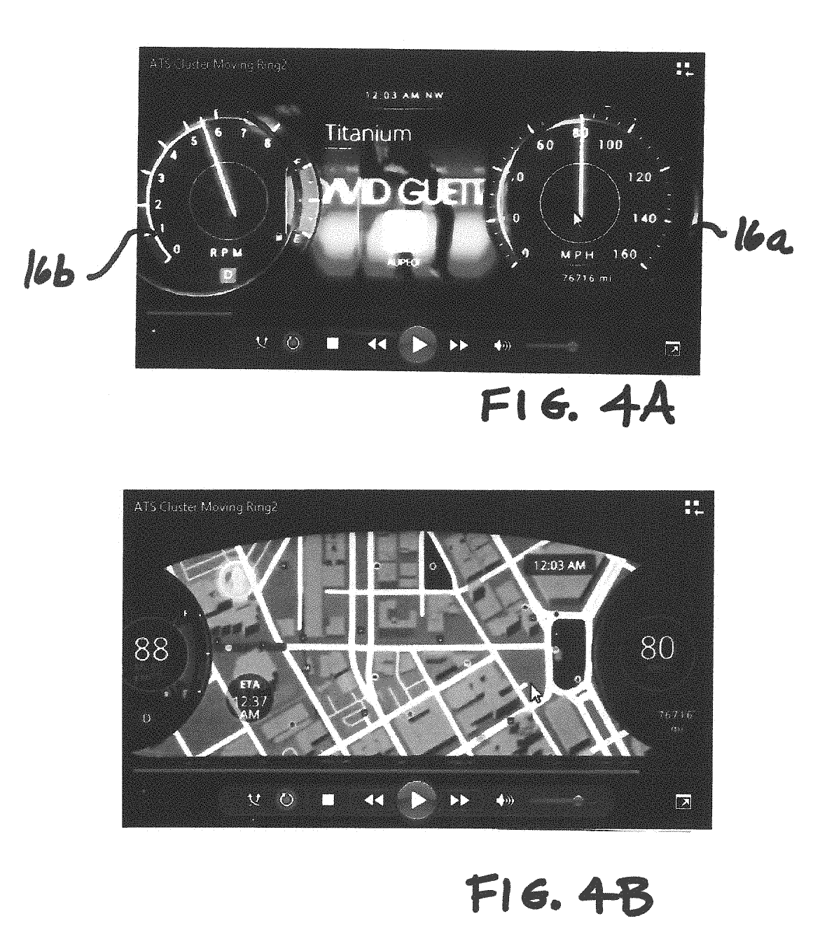

FIG. 4a is yet another view of display screen arrangement 10 in the position of FIG. 2a and with display screen 18 operating. Jewel 16a is shown being disposed over a two-dimensional speedometer, but is shown as being slightly off center in order to make the location, size and shape of jewel 16a more apparent in the drawing. However, jewel 16a may be better centered on the speedometer in order to make the jewel and the speedometer appear to be one single entity. The size and shape of jewel 16a may approximately match that of the speedometer.

Jewel 16b is shown being disposed over a two-dimensional tachometer, but is shown as being slightly off center in order to make the location, size and shape of jewel 16b more apparent in the drawing. However, jewel 16b may be better centered on the tachometer in order to make the jewel and the tachometer appear to be one single entity. The size and shape of jewel 16b may approximately match that of the tachometer.

FIG. 4b is yet another view of display screen arrangement 10 in the position of FIG. 2b and with display screen 18 operating. In this operating mode, a navigation map occupies a large portion of the middle of the screen, and thus jewels 16a-b are located in more laterally-outward positions. Jewel 16a is shown being disposed over a two-dimensional digital speedometer. The size and shape of the portion of jewel 16a that overlies screen 18 may approximately match that of the speedometer. Jewel 16a may make the speedometer appear more three-dimensional.

Jewel 16b is shown being disposed over a two-dimensional miles-to-empty indicator. The size and shape of the portion of jewel 16b that overlies screen 18 may approximately match that of the miles-to-empty indicator. Jewel 16b may make the miles-to-empty indicator appear more three-dimensional.

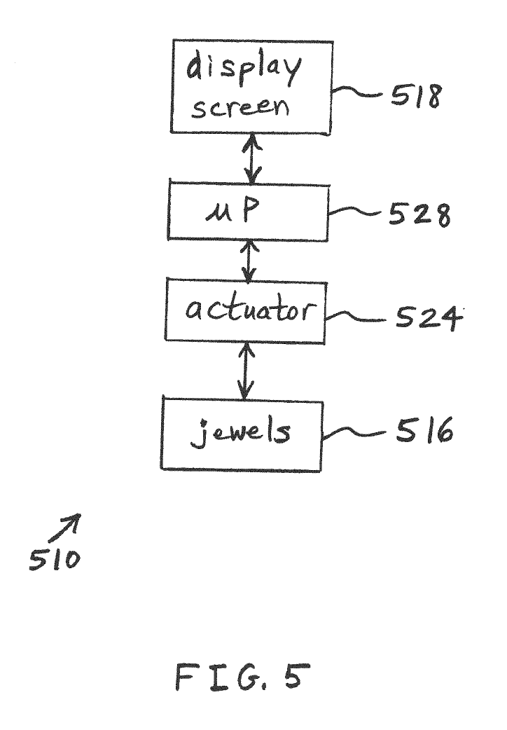

FIG. 5 illustrates another embodiment of a display screen arrangement 510 of the present invention, including a display screen 518, an electronic processor 528, an actuator 524, and optical elements in the form of jewels 516. During use, jewels 516 may be slidably mounted over display screen 518 and may be movable in opposite lateral directions. Actuator 524, which may be a drive motor, is coupled to jewels 516, and may move jewels 516 in the opposite lateral directions. Processor 528 is communicatively coupled to actuator 524 and causes actuator 524 to move jewels 516 to positions dependent upon an image being presented on the display screen. For example, if processor 528 causes display screen 518 to present the speedometer and tachometer of FIG. 4a, then jewels 516 may be positioned over the speedometer and tachometer as shown in FIG. 4a. On the other hand, if processor 528 causes display screen 518 to present the digital miles-to-empty indicator and digital speedometer of FIG. 4b, then jewels 516 may be positioned more laterally outwardly such that jewels 516 overlay the digital miles-to-empty indicator and digital speedometer.

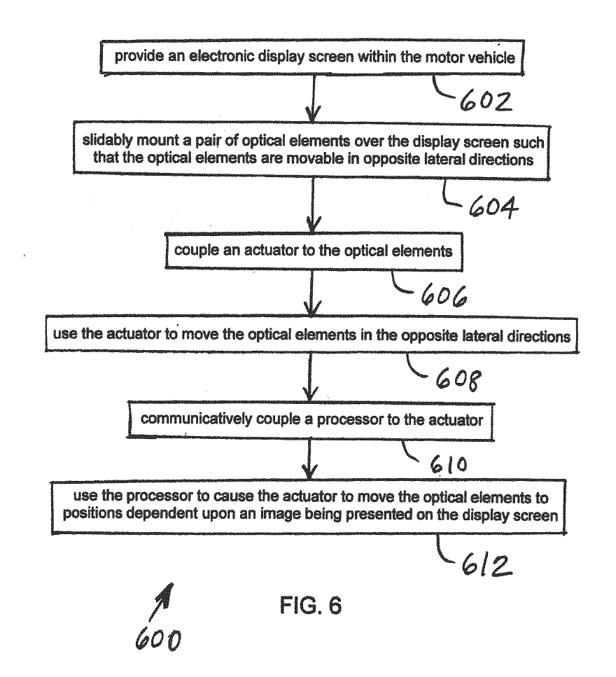

FIG. 6 illustrates a method 600 of the present invention for operating a display screen arrangement in a motor vehicle. In a first step 602, an electronic display screen is provided within the motor vehicle. For example, electronic display screen 18 may be provided in a motor vehicle.

In a next step 604, a pair of optical elements are slidably mounted over the display screen such that the optical elements are movable in opposite lateral directions. For example, jewels 16a-b are laterally slidable over and respect to display screen 18 in opposite directions 20.

Next, in step 606, an actuator is coupled to the optical elements. For example, motor 24 and belt 26 may be coupled to jewels 16a-b via brackets 14a-b.

In step 608, the actuator is used to move the optical elements in the opposite lateral directions. For example, motor 24 and belt 26 may drive brackets 14a-b and jewels 16a-b in directions 20.

In a next step 610, a processor is communicatively coupled to the actuator. For example, an electronic processor 528 is in bidirectional communication with actuator 524.

In a final step 612, the processor is used to cause the actuator to move the optical elements to positions dependent upon an image being presented on the display screen. That is, processor 528 causes actuator 524 to move jewels 516 to positions dependent upon an image being presented on display screen 518. For example, if display screen 518 presents the speedometer and tachometer of FIG. 4a, then jewels 516 may be positioned over the speedometer and tachometer as shown in FIG. 4a. On the other hand, if display screen 518 presents the digital miles-to-empty indicator and digital speedometer of FIG. 4b, then jewels 516 may be positioned more laterally outwardly such that jewels 516 overlay the digital miles-to-empty indicator and digital speedometer.

Although this disclosure may describe a pair of jewels, it is also within the scope of the invention for there to be only one jewel. This disclosure may also describe the jewels as being moved in lateral or left and right directions. However, it is also within the scope of the invention for the jewels to be moved in directions toward and away from the driver, or in up and down directions generally parallel to the surface of the instrument panel.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A display screen arrangement for use in a motor vehicle, the arrangement comprising:
an electronic display screen;
a pair of optical elements slidably mounted over the display screen and movable in opposite lateral directions;
an actuator coupled to the optical elements and configured to move the optical elements in the opposite lateral directions; and
a processor communicatively coupled to the actuator and configured to cause the actuator to move the optical elements to positions dependent upon an image being presented on the display screen.

2. The arrangement of claim 1 wherein the optical elements are substantially transparent.

3. The arrangement of claim 1 further comprising a pair of brackets, each said bracket interconnecting a frame of the electronic display screen and a respective one of the optical elements.

4. The arrangement of claim 3 further comprising a rod attached to the frame of the electronic display screen, each of the brackets being slidably coupled to the rod.

5. The arrangement of claim 1 wherein the rod is substantially horizontally oriented.

6. The arrangement of claim 1 wherein the actuator comprises a motor.

7. The arrangement of claim 1 wherein the processor is configured to cause the actuator to move the optical elements to positions substantially superimposed over respective elements in the image being presented on the display screen.

8. A method of operating a display screen arrangement in a motor vehicle, the method comprising:
providing an electronic display screen within the motor vehicle;
slidably mounting a pair of optical elements over the display screen such that the optical elements are movable in opposite lateral directions;
coupling an actuator to the optical elements;
using the actuator to move the optical elements in the opposite lateral directions;
communicatively coupling a processor to the actuator; and
using the processor to cause the actuator to move the optical elements to positions dependent upon an image being presented on the display screen.

9. The method of claim 8 wherein the optical elements are transparent magnifying elements.

10. The method of claim 8 further comprising providing a pair of brackets, each said bracket interconnecting a frame of the electronic display screen and a respective one of the optical elements.

11. The method of claim 10 further comprising attaching a rod to the frame of the electronic display screen, each of the brackets being slidably coupled to the rod.

12. The method of claim 8 wherein the rod is substantially horizontally oriented.

13. The method of claim 8 wherein the actuator comprises a motor.

14. The method of claim 8 further comprising using the processor to cause the actuator to move the optical elements to positions substantially superimposed over respective elements in the image being presented on the display screen.

15. A display screen arrangement for use in a motor vehicle, the arrangement comprising:
an electronic display screen;
an optical element slidably mounted over the display screen;
an actuator coupled to the optical element and configured to move the optical element across the display screen; and
a processor communicatively coupled to the actuator and configured to cause the actuator to move the optical element dependent upon images being presented on the display screen.

16. The arrangement of claim 15 wherein the optical element is substantially transparent.

17. The arrangement of claim 15 further comprising a bracket interconnecting a frame of the electronic display screen and the optical element.

18. The arrangement of claim 17 further comprising a horizontally oriented rod attached to the frame of the electronic display screen, the bracket being slidably coupled to the rod.

19. The arrangement of claim 15 wherein the actuator comprises a motor.

20. The arrangement of claim 15 wherein the processor is configured to cause the actuator to move the optical element to positions substantially superimposed over respective elements in the images being presented on the display screen.
